(19) United States
(12) Patent Application Publication
(10) Pub. No.: US 2013/0063452 A1
(43) Pub. Date: Mar. 14, 2013

(54) CAPTURING SCREEN DISPLAYS IN VIDEO MEMORY AND DETECTING RENDER ARTIFACTS

(71) Applicants: Imran Ali, Redmond, WA (US); Andrei Baioura, Redmond, WA (US); Jin Jia, Redmond, WA (US); Deepali Bhagvat, Redmond, WA (US); Michael Haight, Bellevue, WA (US); Hiroshi Nagata, Duvall, WA (US)

(72) Inventors: Imran Ali, Redmond, WA (US); Andrei Baioura, Redmond, WA (US); Jin Jia, Redmond, WA (US); Deepali Bhagvat, Redmond, WA (US); Michael Haight, Bellevue, WA (US); Hiroshi Nagata, Duvall, WA (US)

(73) Assignee: MICROSOFT CORPORATION, Redmond, WA (US)

(21) Appl. No.: 13/229,780

(22) Filed: Sep. 12, 2011

(51) Int. Cl. G06F 15/80; G09G 5/36

(52) U.S. Cl. 345/505; 345/547

(57) ABSTRACT

Image data is captured from a specified area of a rendered screen display from the video memory for a number of frames. The image data can be captured in another area of video memory, enabling a video memory to video memory copy to be performed, thus bypassing system memory. This captured image data can be synchronized with event trace data, or other metadata from the operating system, associated with the application. Analysis tools can read and analyze the captured image data in real time to detect and report render artifacts. A graphics processing unit can implement the analysis and operate on the image data directly in the video memory. Such analysis can include a statistical analysis of the images in a sequence of screen captures to identify outliers in the sequence. These outliers have render artifacts.

### BACKGROUND

A common error that can occur with computer programs is the appearance of artifacts on the computer screen during rendering of the user interface for the program. An artifact is an incorrect display of a visual object on the computer screen, examples of which include mispaints, flashes, misaligned content, lingering images, animation glitches, jagged movements and the like. There can be a wide variety of causes of such artifacts. These rendering artifacts are just like other errors, or “bugs,” in computer programs and computer systems because they are undesirable and affect the user's experience and satisfaction.

Static rendering artifacts which persist for a large number of frames are easy to detect, especially if they are repeatable. Static rendering artifacts can be captured and analyzed using a variety of techniques. However, some rendering artifacts are transient, in that they are intermittent, dynamic and/or persist for small number of frames and then go away, making them difficult to capture and analyze.

The analytical tools available for detecting static rendering artifacts also are limited. Given static screen captures, a pixel-by-pixel comparison to a base line image, or visual inspection by an individual, are the primary techniques used to identify render artifacts.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The operating system provides a mechanism through which image data is captured from a specified area of a rendered screen display from the video memory for a number of frames. The image data can be captured in another area of video memory, enabling a video memory to video memory copy to be performed, thus bypassing the system memory. This image data can be synchronized with event trace data, or other metadata from the operating system, associated with the application.

Analysis tools can read and analyze the captured image data in real time, or after the capture is complete, to detect and report render artifacts. Such analysis can include a statistical analysis of the images in a sequence of screen captures to identify outliers in the sequence. These outliers have render artifacts. The analysis can be performed by code designed for a graphics processing unit that runs in parallel with a host processor and processes data directly in the video memory.

Accordingly, in one aspect, an area of a screen to capture is specified. Image data for the specified area of the screen is captured from video memory allocated to a display, for a number of frames at a capture rate, by copying the image data to an atlas memory. The atlas memory can be another area of the video memory. The captured image data is captured in an area of video memory having an allocated size corresponding to the number of frames and the size of the area of the screen to be captured. Event trace data can be captured from a period of time during which the capturing of image data was performed and correlated with the captured image data. During capturing, a scenario in which image data is rendered for the screen can be executed. The specified area of the screen corresponds to image data rendered in the scenario, so as to enable capturing of the image data rendered in the scenario.

Render artifacts in the scenario can be detected using the captured image data. For example, statistical analysis can be applied to the captured image data to identify render artifacts. The statistical analysis can involve computing differences between histograms of the captured image data. Statistical outliers are identified using the computed differences, wherein the statistical outliers contain render artifacts.

In another aspect, a computing machine includes a video memory allocated to a display and a rendering engine that renders image data for a screen in the video memory. A capture module accesses the video memory and captures image data for a specified area of the screen, for a number of frames at a capture rate, into an atlas memory.

Render artifacts can be detected using the captured image data.

In another aspect, render artifacts can be detected in image data captured from the video memory by applying a statistical analysis to a sequence of images from a sequence of frames. Statistical outliers have render artifacts. As an example, a histogram of each color (R, G, B) channel is computed from the image data for each frame. Differences in histograms for neighboring frames are computed. Statistical outliers are identified using the histogram differences.

Render artifact detection can be implemented in computer program instructions that are processed by a graphics processing unit (GPU) instead of the host processor. This analysis can be performed on the captured image data in the video memory. By capturing image data in another area of video memory, bypassing copying to host memory, and then processing image data using the GPU, enabling parallel execution of instructions optimized for processing graphics data, the speed of render artifact detection is drastically increased. Thus, render artifacts can be detected in a specified region of the screen in real time, or near real time.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of a computer system incorporating screen capture and render artifact detection.

FIG. 2 is a more detailed data flow diagram illustrating an example implementation of screen capture.

FIG. 3 is a flow chart describing an example operation of screen capture.

FIG. 4 is a more detailed data flow diagram illustrating an example implementation of render artifact detection.

FIG. 5 is a flow chart describing an example operation of render artifact detection.

FIG. 6 is a block diagram of an example computing device in which such a system can be implemented.

### DETAILED DESCRIPTION

The following section provides an example operating environment in which screen capture and render artifact detection can be implemented.

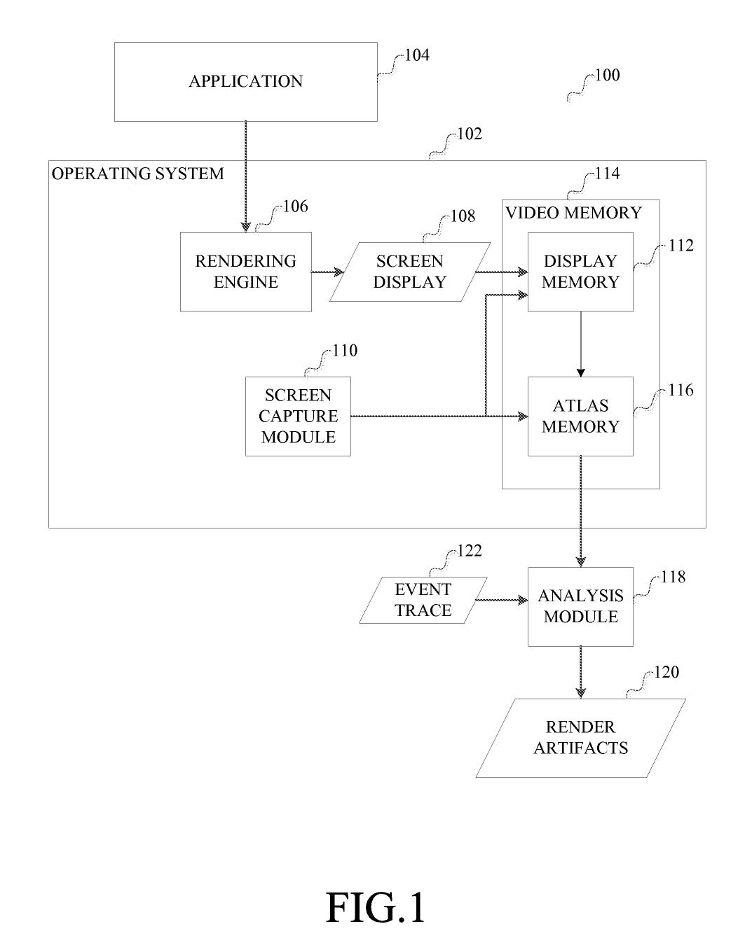

Referring to FIG. 1, a computer system 100 includes an operating system 102 and an application 104 running on the operating system 102. Within the operating system, a rendering engine 106 is responsive to requests from an application to generate a screen display 108 for the application. The rendering engine 106 generates image data for the screen display in a portion 112 of the video memory 114 allocated to a display (not shown). A screen capture module 110 reads image data from the video memory 112 into an atlas memory 116, for each frame generated by the rendering engine 106. The image data is read from the video memory for the screen display, and thus each capture frame is the frame that is displayed on the screen. The atlas memory 116 can be another portion of the video memory 114 to enable a video memory to video memory copy to be used. The image data captured by the screen capture module can be any portion of the screen display 108. This portion can be defined by a window for an application which is being monitored, or can be user defined, for example.

The operating system 102 can emit event trace data 122 or other information about how the application 104 is running, such as parameters provided to the rendering engine. The event trace also can have information about how the operating system is running, because events also can originate from the operating system and can include information about various operating system components. This data can be correlated with the captured image data as described below.

The atlas memory 116 is accessible by an analysis module 118 which performs image analysis on the image data to detect, and provide information about, render artifacts as indicated at 120. The analysis module 118 can be implemented so as to run on a graphics processing unit (GPU), by being written in a GPU's shader language, and can operate on the image data directly in the atlas memory 116 in the video memory 114. Thus the capture and analysis can happen in real time. The analysis module 118 also can use the event trace data 122 to identify events occurring during screen captures.

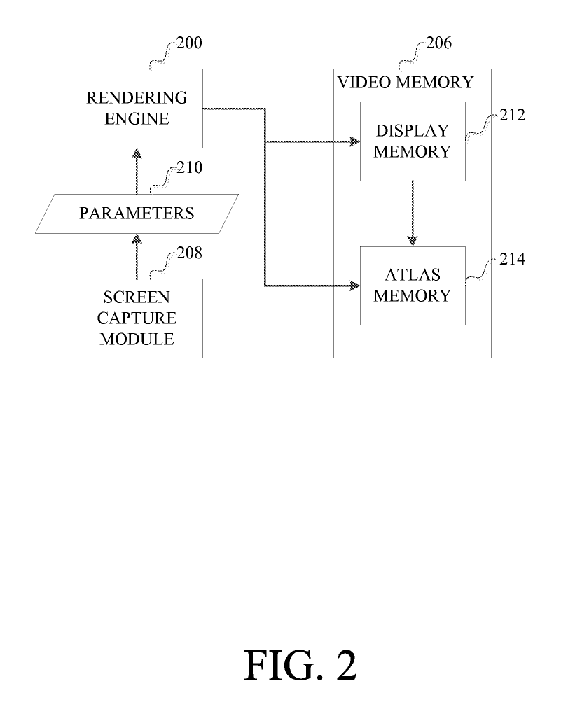

Given this context, an example implementation of screen capture and render artifact detection will be described in more detail in connection with FIGS. 2-5.

In one example implementation shown in FIG. 2, a rendering engine 200 uses information from applications to generate image data for the screen in a portion 212 of a video memory 206. This portion 212 holds image data that is provided to a display. The rendering engine has an application programming interface through which the screen capture module 208 provides parameters 210 for capturing image data from the screen. The parameters include information that enables the rendering engine to know which area of the screen to capture, a frequency or rate of capture, a number of frames to capture, when to start and stop capture, and locations in memory in which to store the captured frames.

The area of the screen can be defined, for example, by a rectangle in x, y coordinates in the screen or desktop coordinate space, or by identifying a window, or the like. The frequency can be defined, for example, as a number of frames per second, or as a function of the refresh rate of the desktop or screen (e.g., every other screen), or the like. The number of frames to be captured can be defined, for example, by a number, or by a period of time, user input stopping capture, or the like. When to start and stop capture can be defined, for example, by a specified time or event, such as an application event or user input, or the like. In some case, the stop time is inferred from the start time, the number of frames and frequency of capture. The stop time also can be determined by the amount of memory available for capturing image data. This information can be derived from user inputs provided through a user interface for the screen capture module 208.

The rendering engine 200 captures the specified image data and writes it to a portion 214 of video memory 206 herein called the atlas memory. The atlas memory is allocated in the video memory and has a size corresponding to the region of the screen to be captured and the number of frames to capture. By using video memory, a video memory to video memory copy can be performed to capture the screen data. For each frame, the rendering engine 200 writes image data to this atlas memory, until capture ends. At the end of capture, the atlas memory contains several frames of the screen which can then be analyzed to detect render artifacts.

Event trace data can be correlated with the captured frames by capturing the event traces between the start and stop times of the screen capture. As an example implementation, an identifier for a screen capture session is passed to an event generation system. When screen capture starts and ends, and for each captured frame, an event including this parameter is generated by the event generation system. Thus, the event trace data contains events corresponding to individual screen captures. Knowing when these screen capture events occurred, the analysis module can determine which frames correspond to which events. Trace data can include other events, and the analysis module can determine which events preceded and followed which captured frames.

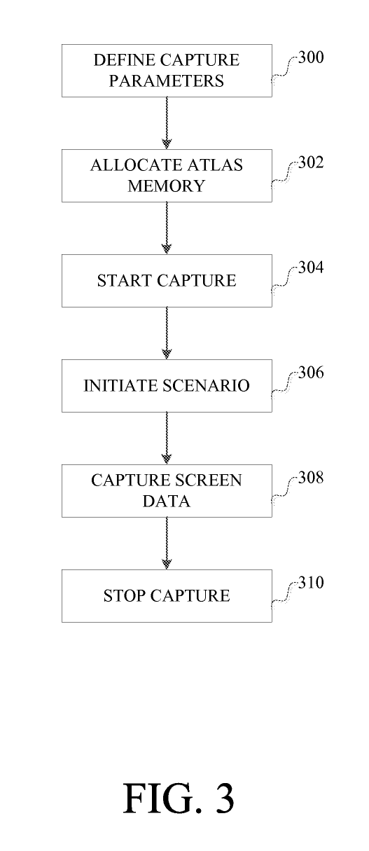

Referring now to FIG. 3, a flowchart describing an example operation of screen capture in FIG. 2 will now be described.

First, a set of capture parameters are defined 300, so as to define the screen area and the number of frames to be captured. The atlas memory is allocated 302 based on this screen area and number of frames. Next, capturing is started 304. The scenario for which the capturing is being performed is then initiated 306. In particular, the application which is causing render artifacts can be run. While the capturing process is running and the application is running, screen data is captured 308. At some point, the capture process is otherwise stopped 310, for example if the atlas memory becomes full or if the designated number of frames have been captured.

Given this process for capturing screens, it can be noted that there is no separate rendering pass for capturing the screen. The data rendered to the screen is copied directly to the atlas memory. Thus, the actual content that is displayed on the screen is captured. Further, by copying the screen data using a video memory to video memory copy on each frame when the screen is updating, capture occurs at a high frequency and can match the screen refresh rate. Finally, the capture process is asynchronous. Thus, a specified area of the screen can be captured, asynchronously with the application, until capturing is terminated or a maximum frame limit is reached.

Having now described screen capture, image analysis for render artifact detection will now be described.

In general the render artifacts can be detected by applying various filters to the image data, and then analyzing the filtered data. The specific implementation of any filter or analysis, and combination of them, is dependent on the kind of render artifact being detected. In one implementation, the filters and analyzers can be constructed in a form of computation graph written in a shader language recognized by the graphics processing unit (GPU), which may be considered a shader tree, which can be executed in real time by the GPU without significantly impacting the application running on the computer. This analysis can be applied to the image data in the video memory without further copying it to system memory.

The sequence of images can be analyzed statistically, which avoids using a base line image for comparison. A statistical analysis can be used because images with transient artifacts are significantly different from other images in the sequence, and can be identified as statistical outliers in that sequence.

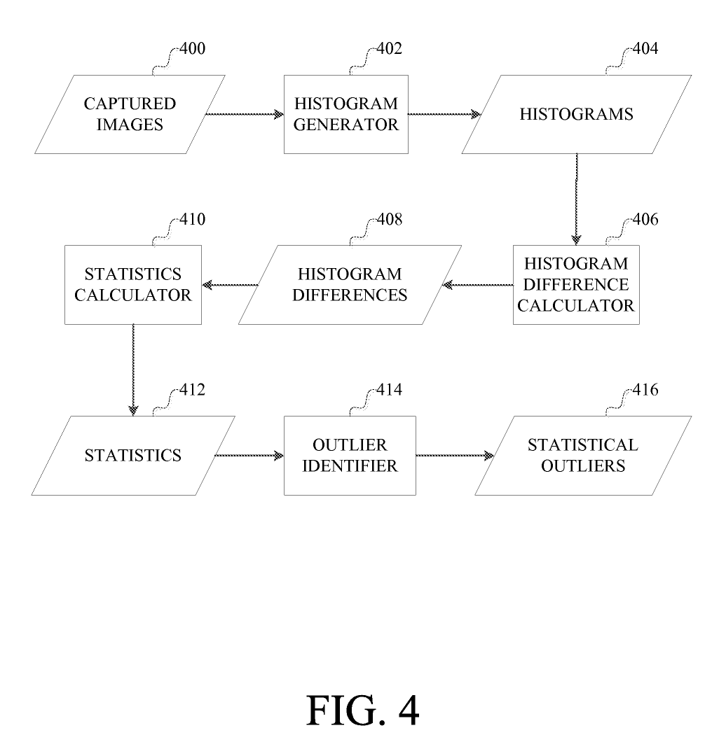

A specific example implementation is shown in FIG. 4. A histogram generator 402 has an input that receives each captured image 400. It provides an output 404 that is a histogram of the pixel intensities in each of the red, green and blue (RGB) channels in the image. For example, each pixel in the image data for a frame can be processed to determine a count of the number of pixels having a particular intensity value over a range of intensity values. The histogram is thus an array of counts of pixels at each intensity value. A histogram difference calculator 406 receives the outputs 404 of the histogram generator, and compares the histogram of each frame with the histogram of one or more neighboring frames. For example, the histogram of a frame can be compared to the histogram of the previous adjacent frame and to the histogram of the next adjacent frame. The histogram difference is the sum of the absolute differences of the histograms of the R, G, B channels. For example, given the histograms for the R, G and B channels of a current frame and a previous frame, then the differences between the histograms for each channel of neighboring frames are computed, and the sum of these absolute differences is computed. The histogram difference indicates how close the frame matches with its neighboring frames in global pixel intensity and distributions and tolerates shift of pixel position values.

The histogram difference 408 output by the histogram difference calculator is provided to a statistics calculator 410. Various statistics across the set of frames are computed, such as: minimum, maximum, average, median, and standard deviation. The statistics 412 are output.

An outlier identifier 414 receives the statistics 412 and identifies the frames that are statistical outliers 416. These frames have render artifacts. As an example implementation, an outlier threshold value is defined as a multiple of the standard deviation from an average value, or it can be defined by statistical values of other global characteristics of the image sequence. The average value is the average histogram difference among the frames in the captured sequence. If, for a given frame, its histogram difference with respect to a previous frame is different from the average by the outlier threshold value, and its histogram difference with respect to a next frame is different from the average by the outlier threshold value, then the frame is an outlier.

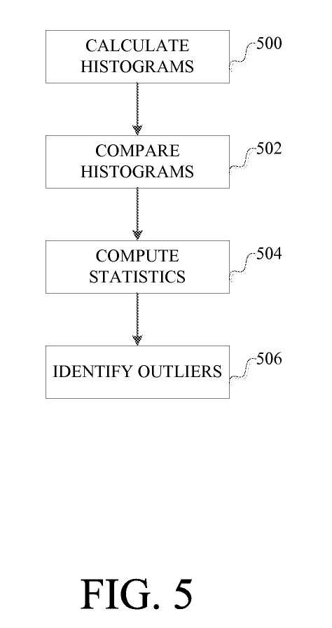

Referring now to FIG. 5, a flowchart describing an example operation of render artifact detection in FIG. 4 will now be described.

Given a set of captured images in the video memory, a histogram is calculated 500 by the computer for each image and stored in memory. The histogram of each image is compared 502 by the computer to the histograms of one or more neighboring images to obtain a histogram difference which is stored in memory. Statistics for the histogram differences of the frames are computed 504 by the computer and stored in memory. From these statistics, outliers are identified 506 by computer, which are the frames with render artifacts.

It should be understood that the foregoing is merely an example implementation of statistical analysis that is based on a histogram being computed for each frame. Histograms are useful for performing global image matching in a manner that tolerates gradual changes between frames (gradual changes in pixel values, position shifting, etc.). The changes are gradual in a user interface because each frame in a sequence of frames has spatial and temporal relationships with neighboring frames. A frame in a user interface that has artifacts exhibits a large and sudden histogram difference in comparison to neighboring frames.

Other analyses can be performed to identify a variety of render artifacts. For example, black flashes on a screen can be detected by looking for large counts of black pixels. The processing also can involve applying blur filters to image data prior to statistical processing.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

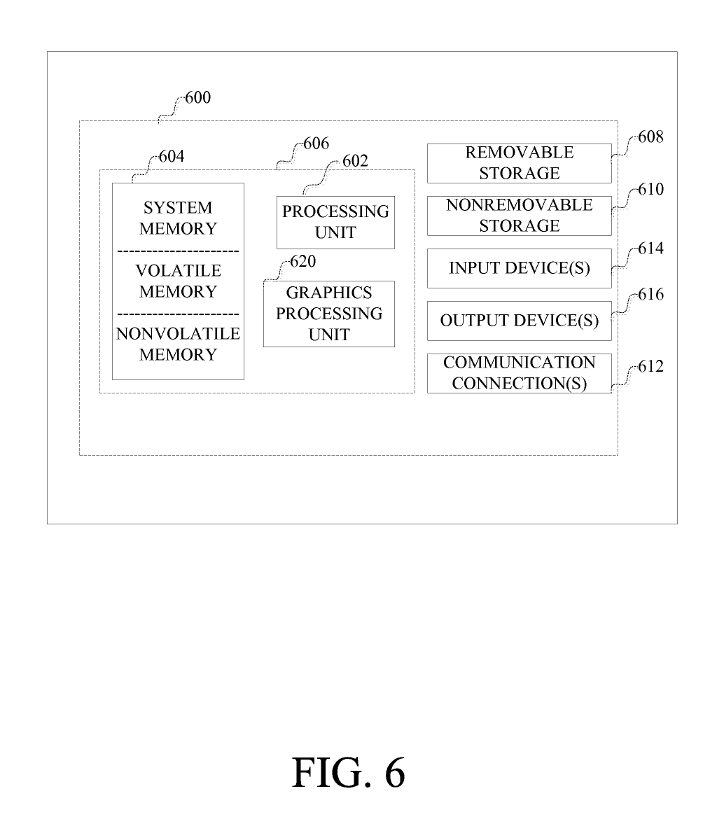

FIG. 6 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 6, an example computing environment includes a computing machine, such as computing machine 600. In its most basic configuration, computing machine 600 typically includes at least one processing unit 602 and memory 604. The computing device may include multiple processing units and/or additional co-processing units such as graphics processing unit 620. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. Additionally, computing machine 600 may also have additional features/functionality. For example, computing machine 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer program instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 600. Any such computer storage media may be part of computing machine 600.

Computing machine 600 may also contain communications connection(s) 612 that allow the device to communicate with other devices. Communications connection(s) 612 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 600 may have various input device(s) 614 such as a keyboard, mouse, pen, camera, touch input device, and so on. Output device(s) 616 such as a display, speakers, a printer, and so on may also be included. All of these devices are well known in the art and need not be discussed at length here.

Such a system can be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
specifying an area of a screen to capture;
capturing image data for the specified area of the screen from video memory allocated to a display, for a number of frames at a capture rate, by copying the image data to an atlas memory.

2. The computer-implemented process of claim 1, wherein the atlas memory is another area of the video memory.

3. The computer-implemented process of claim 1, further comprising:
capturing event trace data from a period of time during which the capturing of image data was performed; and
correlating the event trace data with the captured image data.

4. The computer-implemented process of claim 1, further comprising:
during capturing, executing a scenario in which image data is rendered for the screen;
and wherein the specified area of the screen corresponds to image data rendered in the scenario, so as to enable capturing of the image data rendered in the scenario.

5. The computer-implemented process of claim 1, further comprising:
applying statistical analysis to the captured image data to identify render artifacts.

6. The computer-implemented process of claim 4, wherein the statistical analysis comprises:
computing differences between histograms of the captured image data; and
identifying statistical outliers using the computed differences, wherein the statistical outliers contain render artifacts.

7. The computer-implemented process of claim 2, wherein the statistical analysis is performed using a graphics processing unit that accesses the captured image data in the video memory in parallel with a host processor.

8. An article of manufacture comprising:
a computer storage medium;
computer program instructions stored on the computer storage medium which, when processed by a processing device, instructs the processing device to perform a process comprising:
specifying an area of a screen to capture;
capturing image data for the specified area of the screen from video memory allocated to a display, for a number of frames at a capture rate, by copying the image data to an atlas memory.

9. The article of manufacture of claim 8, wherein the atlas memory is another area of the video memory.

10. The article of manufacture of claim 8, wherein the process performed further comprises:
capturing event trace data from a period of time during which the capturing of image data was performed; and
correlating the event trace data with the captured image data.

11. The article of manufacture of claim 8, wherein the process performed further comprises:
during capturing, executing a scenario in which image data is rendered for the screen;
and wherein the specified area of the screen corresponds to image data rendered in the scenario, so as to enable capturing of the image data rendered in the scenario.

12. The article of manufacture of claim 8, wherein the process performed further comprises:
applying statistical analysis to the captured image data to identify render artifacts.

13. The article of manufacture of claim 12, wherein the statistical analysis comprises:
computing differences between histograms of the captured image data; and
identifying statistical outliers using the computed differences, wherein the statistical outliers contain render artifacts.

14. The article of manufacture of claim 9, wherein the statistical analysis is performed using a graphics processing unit that accesses the captured image data in the video memory in parallel with a host processor.

15. A computing machine comprising:
a video memory allocated to a display;
a rendering engine that renders image data for a screen in the video memory;
a capture module that accesses the video memory and captures image data for a specified area of the screen, for a number of frames at a capture rate, into an atlas memory.

16. The computing machine of claim 15, wherein the atlas memory is another area of the video memory.

17. The computing machine of claim 16, wherein the captured image data is captured in an area of video memory having an allocated size corresponding to the number of frames and the size of the area of the screen to be captured.

18. The computing machine of claim 15, wherein the capture module further captures event trace data during capture of the image data.

19. The computing machine of claim 15, further comprising:
an analysis module that accesses the atlas memory and performs statistical analysis the captured image data to identify render artifacts.

20. The computing machine of claim 15, wherein the capture module further captures image data during execution of a scenario in which image data is rendered for the screen, wherein the specified area of the screen corresponds to image data rendered in the scenario, so as to enable capturing of the image data rendered in the scenario.
